(19) United States
(12) Patent Application Publication
(10) Pub. No.: US 2015/0253845 A1
(43) Pub. Date: Sep. 10, 2015

(54) SYSTEM AND METHOD FOR ALTERING A PERSPECTIVE OF A FIGURE PRESENTED ON AN ELECTRONIC DISPLAY

(71) Applicant: Umoove Services Ltd., Jerusalem (IL)

(72) Inventors: Yitzchak KEMPINSKI, Geva Binyamin (IL); Sophia FRIJ, Maale Adumim (IL)

(21) Appl. No.: 14/639,145

(22) Filed: Mar. 5, 2015

Related U.S. Application Data
(60) Provisional application No. 61/948,047, filed on Mar. 5, 2014.

(51) Int. Cl. G06F 3/01; G06T 3/60; G06T 3/20; G06T 7/20

(52) U.S. Cl. CPC G06F 3/013; G06T 7/20; G06T 3/60; G06T 3/20; G06T 2207/10016; G06T 2207/30201

(57) ABSTRACT

A method for altering a position of an object in an image on a display screen in response to a position of a viewer of such screen. For example, an image of a person that is displayed on a screen may be altered to face or be directed towards a viewer of the screen that is detected by for example a sensor, so that the image of the person on the screen appears to look at the viewer who is looking at the screen.

### CROSS REFERENCE TO RELATED APPLICATION

This application claims benefit of prior U.S. Provisional Patent Application No. 61/948,047 filed on Mar. 5, 2014 and entitled “System and Method for Altering a Perspective of a Figure Presented on an Electronic Display”, incorporated herein by reference.

### BACKGROUND OF THE INVENTION

A viewer of content or listener of a message or conversation may be more attentive to the message or speech when the speaker is looking at the viewer or into the eyes of the viewer or listener. Further, a viewer of material such as advertising material may be more attentive to the content when an image of a reader or presenter of the content is looking at the viewer.

### SUMMARY OF THE INVENTION

Embodiments of the invention include a system and method of designating or altering a position, orientation or perspective of one or more of eyes, head, face, or body of an image, character, depiction or graphic presented on an electronic screen or display, to match, reflect or otherwise accommodate a location of a person or viewer of the screen relative to the screen, image or depiction. For example, a perspective or angle of eyes, face, head or body of an image, graphic or other depiction that is presented on an electronic display may be moved or altered so that for example the eyes, face or body of the image appear to face a viewer or follow a movement of a person or viewer as the viewer moves relative to the screen or to the object depicted on the screen. A perspective or orientation of the object displayed on a screen may therefore face a viewer or person, or may move or change perspectives or orientation to follow a moving viewer. In some embodiments, a portion of the depicted image may appear to move in smooth motions, or look at the viewer or otherwise act or appear in a particular way in response to the viewer's movement or gaze, or in response to a person's location in for example an area in front of or in a same room as the screen. For example, the eyes of a depicted figure may look at the person or viewer, or may appear to follow a person or viewer or a viewer's eyes as the viewer or the viewer's eyes move.

### BRIEF DESCRIPTION OF THE DRAWINGS

FIG. 1 is a schematic diagram of components of a system according to embodiments of the invention.

FIG. 2 is a schematic diagram of a display device according to an embodiment of the invention.

FIG. 3 depicts a showing a 2D (two dimensional) camera or imager having a field of view.

### DETAILED DESCRIPTION OF THE INVENTION

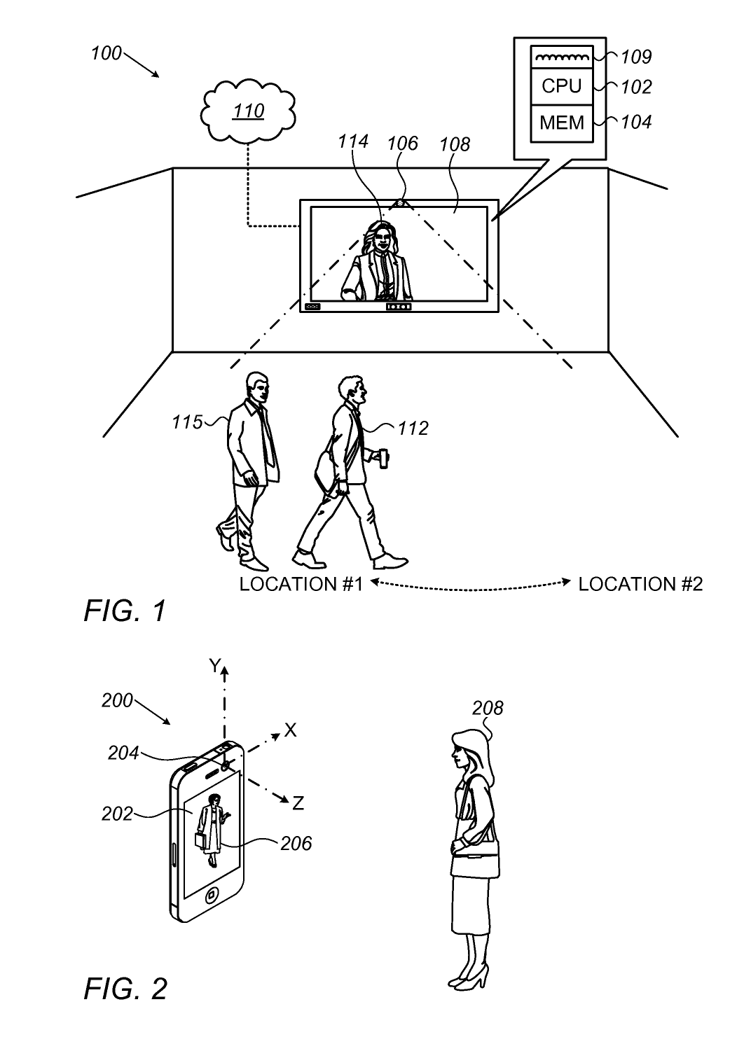

Reference is made to FIG. 1, a schematic diagram of components of a system in accordance with an embodiment of the invention. A system 100 may include a processor 102, an electronic display or screen 108, a memory 104, a sensor such as an infra-red sensor, sound-based sensor, or imager 106 such as a camera that may be located at a location that is known relative to screen 108. Some or all of such components may be part of, attached to or associated with a computer, television monitor, portable computer, cellular telephone, tablet computer or other electronic device. In some embodiments, system 100 may be associated, by way of a communication device 109 such as a wired or wireless receiver, with a network 110 such as for example a cellular network or the Internet, and with a remote server. A viewer 112 such as a person, may be viewing or in an area proximate to screen 108, and viewer 112 may be in a field of view of sensor or imager 106. Screen 108 may display one or more images, graphics or other depictions of for example, people, animals, cartoon characters or other objects 114.

In some embodiments, viewer 112 may be detected in a particular position or location relative to screen 108, or viewer may move, alter a position or otherwise change an orientation or location relative to screen 108, and sensor or imager 106 may detect such position, location, motion, movement or change in position of viewer 112. In some embodiments, a depicted image may assume or alter a position, perspective or orientation, such as by looking or facing in a direction of the viewer, immediately or at some other time after the depicted image is shown on the display. For example, embodiments of a method may locate a position of a user relative to the screen 108, and may angle or alter one or more positions or perspectives of all or some objects that appear on the screen 108 to reflect such location of the viewer relative to the display. For example, sensor or imager 106 may issue a signal to processor 102 which may calculate or detect that a head, eyes, face or body of viewer 112 in an image has moved from being at for example a 90° angle relative to screen 108 or to object 114 depicted on screen 108, to being at a 45° angle relative to screen 108 or to figure or object 114 on the screen. In some embodiments, sensor or imager 106 may detect both a distance and an angle of viewer 112 from screen 108, and processor 102 may calculate a location of viewer 112 in space or relative to screen 108 or to the figure 114 on the screen.

In some embodiments, memory 104 or some other memory may store or receive two or more images of object 114, as such images may reflect a viewing angle of object 114. For example, a first image or stream of images or videos of object 114 may present a view of object 114 as if a viewer was viewing object 114 at a 90° angle from screen 108 or from the position or location of the object 114 on the screen 108. A second image, stream of images or videos may present object 114 as if it is being viewed from a 45° angle to the right of screen 108, so that the face, head or other part of the object appears to turn or rotate to face or to look at the viewer 112. In some embodiments, a viewer may not be viewing object 114, but a perspective of object 114 may be angled or altered so that it faces the viewer. A third stream of images or videos may present object 114 as if it is being viewed from a 45° angle from a left of screen 108 or from a location of a depiction of object 114 on screen 108. In some embodiments, a viewer 112 may not actually be looking at the object 114 or screen 108, but may rather just be in a position, location or area where there is a line of site to the screen 108 or object. Other or additional images representing object 114 at other angles and other directions may also be used. In some embodiments one or more images, stream of images or videos may be altered by for example processor 102 to present or create a view of object 114 as it appears on a screen 108, as if object 114 were rotated to face or to look at a given angle relative to a front of screen 108. In some embodiments, a perspective of a portion of object 114 may be rotated as presented on screen 108, while another portion of object 114 presented on screen may remain at an original or given angle. For example, a head, face or eyes or other part of object 114 may be rotated or presented at a first angle, while a rest of object 114 may be presented at a second angle. Such various angles may depict for example a head or eyes of object 114 turning or turned to an angle while a depiction of a body of object 114 is presented at 90°, or not turned to face the viewer 114.

In operation, a viewer 112 may at a first period view object 114 on screen 108 at or from a first angle relative to screen 108 or to object 114, such as facing screen 108 or the object on screen from straight ahead and in front of screen or object on screen 108. Imager or sensor 106 may detect in a second period that viewer 112 has moved relative to screen 108 or relative to the object on screen, to a place relative to the depiction of object 114 on screen 108, or to imager or sensor 106 which is at a known position relative to screen 108 and to object 114 on screen 108. Imager or sensor 106 may for example compare an image or locations captured in the first period with an image or locations captured in the second period to determine if the position of viewer 112 or a part of viewer 112 such as eyes, face, head or body, has changed between the first and the second period.

In some embodiments, a face, eyes, head or body of object 114 may be presented on screen 108 towards or facing a viewer 112 that is detected at a time that the object 114 is displayed on screen 108 or at some other time, as viewer for example moves around a room or back and forth in a field of view of imager or sensor range 106. In some embodiments, a particular viewer may be selected or pre-programmed to be followed by imager or sensor 106, and a perspective of object 114 may reflect a position or angle of such selected or particular viewer. In some embodiments, imager 106 or processor may detect that viewer 112 has left a field of view of imager, whereupon a second or alternate viewer 115 may be selected or found, and a perspective of object 114 may be presented on screen 108 to reflect the location or angle of viewer 115. In some embodiments, a system may track more than one viewer or person, and a perspective of object 114 may for example alternate between a first tracked person and a second tracked person, or different objects or set of objects may be set to track different people.

Some embodiments may include a method of presenting a figure on an electronic display, by for example detecting in a first period, a first location of a viewer of the display, and presenting during the first period the figure on the display at a first perspective, where the first perspective is towards the first location. The method may detect in a second period, that the location of the viewer has changed to a second location. The method may present on the display the figure at a second perspective, where the second perspective is towards the second location.

In some embodiments, a perspective of only a portion of the figure may be towards the second location, where the portion of the figure may be selected from for example a body of the figure, a head of the figure, a face of the figure or eyes of the figure. For example, the eyes or face of an object or figure displayed on a screen may be rotated or adjusted to follow a viewer's movement in front of a screen or camera, while a rest of the figure or object remains facing forward or at some other angle. In some embodiments, the eyes, face, head or body of a viewer may be tracked by a camera or sensor, and a movement of the eyes of the figure may be responsive to the movement of the eyes, face, head or body of the viewer. For example, if a viewer looks to the left, the figure in the display may look in the same direction, as if the displayed figure is trying to see what the viewer is looking at. In some embodiments, a signal may be transmitted to a processor that may be associated with the displayed images to move the eyes of the displayed figure in a pattern that matches the movement of eyes of a real person in a conversation. For example, a series of patterns may be recorded of the eye movements of participants in a conversation, and the way one or more eye movements of one party to the conversation are responsive to eye or head movements of another party to the conversation. Such patterns may be recorded in a memory, and upon a detection that a viewer's eye/head/face/body movements match a known pattern, the eye/head/face/body movement of the depicted figure may be altered to match the stored pattern of movements of the other side to the conversation.

Reference is made to FIG. 2, a schematic diagram of a display device in accordance with an embodiment of the invention. A device 200 may include a display 202 and may be associated with an image capture device or camera 204 which may be at a known distance (in for example centimeters) and position on each of an X, Y and Z axis relative to display 202. The origin of each such axis may be assumed to be a center of camera 204. A horizontal and vertical field of view (FOV) of camera 204, and the resolution in pixels of camera 204 may be known. In some embodiments, a position or orientation of a figure 206 or object shown on display 202 may be known relative to camera 204 or to some other point on device 200 or display 202.

A face, part of a face, head, eyes or body may be detected and tracked in a frame by application of a face detection and tracking algorithm or object detection algorithm. For example, application of a real time face detection algorithm may include utilizing the Viola-Jones object detection algorithm (using Haar features), or various other face detection or tracking algorithms included in the Open Source Computer Vision Library (OpenCV) or elsewhere. Application of such a face detection or object detection algorithm may detect boundaries of a face in a frame (e.g., features of a face such as an eye strip, an eye region, a nose, or glasses). Application of the face or object detection algorithm may indicate boundaries (e.g., based on a known relationship among facial elements) of one or more regions of the face, such as an eye region. Upon detection, an estimate of a distance in for example centimeters may be made between the viewer 208 and the camera 204.

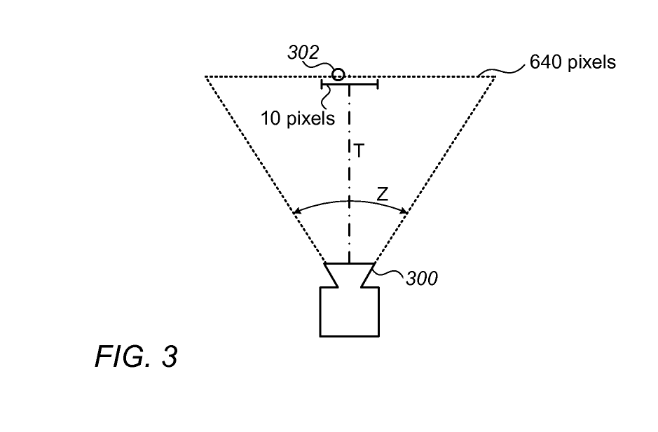

Reference is made to FIG. 3, showing a 2D (two dimensional) camera or imager 300 having a field of view of Z, and capturing for example 640 horizontal pixels in its images. An iris 302, having an assumed width of 1.18 cm may be captured in for example 10 pixels of the 640 pixels. In some embodiments, a location of iris 302 may be determined as is set out in Application PCT/IL2013/050072, entitled System and Method for Tracking of Eyes, as is attached hereto. A distance T of the iris 302 or the viewer from the imager 300 may be calculated from the tangent of Z/2, and based on the width of iris 302 as is derived from the pixels appearing in iris 302 being the equivalent of 1.18 cm. In some embodiments a rectification process may be performed on iris 302 to correct distortions in the shape of the iris that may result from a capture of iris 302 in the image at an angle. Such distance may be calculated by for example, determining the number of pixels that are occupied by the iris 302 of the viewer.

Returning to FIG. 2, based on the distance of the viewer 208 from the camera 204, and on the distance of the camera from display 202 and displayed object 206, and the position of the viewer 208 in the field of view of the camera, a determination may be made of the position of the viewer 208 relative to display 202 in each of an X, Y and Z axis. Finding a location of viewer on a Z axis may be calculated by calculating the T as described above. The X axis calculation may be based on the number of horizontal pixels in an image between the viewer and the displayed object 206, and the Y axis calculation may be based on the number of pixels in the image on a vertical axis between the viewer and the displayed object 206 wherein the viewer is found. In some embodiments, a position of the viewer 208 relative to display 202 may be derived by a three dimensional camera.

In some embodiments, a position of figure 206 as appears on display 202, may be calculated relative to camera 204. An angle or perspective of figure 206 on display 202 may be adjusted or oriented to the position of viewer 208 not only relative to display 202, but also relative to the position on display 202 of the figure 206. Such calculation may require that the position of figure 206 be calculated relative to a position of camera 202. A known position of figure 206 relative to camera 202, and a known position of viewer 208 relative to camera 202, may allow the application of a perspective of figure 206 to face or be directed to viewer 208.

1. A method of presenting a figure on an electronic display, comprising:
detecting in a first period, a first location of a viewer of said display;
presenting in said first period said figure on said display at a first perspective, said first perspective towards said first location;
detecting in a second period, said viewer in a second location; and
presenting in said second period, said figure on said display at a second perspective, said second perspective towards said second location.

2. The method as in claim 1, wherein said presenting in said second period said figure comprises, presenting a portion of said figure selected from the group consisting of a body of said figure, a head of said figure, a face of said figure or eyes of said figure, at said second perspective.

3. The method as in claim 1, wherein said presenting in said second period, said figure on said display at a second perspective, comprises presenting eyes of said figure as following said viewer in a movement by said user from said first location to said second location.

4. A system for presenting a figure on an electronic display, comprising:
an electronic display to display a figure;
a sensor;
a processor; wherein
said sensor is to detect a first location of a viewer of said display in a first period, and to detect a second location of said viewer of said display in a second period;
said processor is to alter a perspective of said figure displayed on said display in response to a change between said first location and said second location.

5. The system as in claim 4, wherein said processor is to alter a perspective of a portion of said figure displayed on said display, said portion selected from the group consisting of a body of said figure, a head of said figure, a face of said figure, and an eye of said figure.

6. A method comprising:
determining a position of a viewer relative to a position of an object displayed on an electronic display, and
presenting said object on said electronic display at a perspective directed to said position of said viewer.

7. The method as in claim 6, comprising calculating a position of said viewer relative to a camera, and a position of said object relative to said camera.
